(19) United States
(12) Patent Application Publication
(10) Pub. No.: US 2026/0228579 A1
(43) Pub. Date: Aug. 6, 2026

(54) LEARNING APPARATUS, ESTIMATION APPARATUS, LEARNING METHOD, ESTIMATION METHOD AND PROGRAM

(71) Applicant: NIPPON TELEGRAPH AND TELEPHONE CORPORATION, Tokyo (JP)

(72) Inventors: Daiki TAKEUCHI, Musashino-shi (JP); Yasunori OISHI, Musashino-shi (JP); Daisuke NIIZUMI, Musashino-shi (JP); Noboru HARADA, Musashino-shi (JP); Kunio KASHINO, Musashino-shi (JP)

(73) Assignee: NIPPON TELEGRAPH AND TELEPHONE CORPORATION, Tokyo (JP)

(21) Appl. No.: 19/143,696

(22) PCT Filed: Jan. 19, 2023
(86) PCT No.: PCT/JP2023/001452

§ 371 Date: Jun. 26, 2025

(51) Int. Cl. G06N 5/045

(52) U.S. Cl. CPC G06N 5/045

(57) ABSTRACT

A learning device including a control unit that performs learning of a mathematical model of a learning target using a first audio signal and a second audio signal, in which the learning target is a disentangling model that estimates, on the basis of an embedding vector of one of two input audio signals and an embedding vector of an other, a high similarity set that is a set in which a degree of similarity between an embedding vector of the one and an embedding vector of the other in an audio feature amount space that is a space indicating a distribution of a feature amount of an embedding vector of an audio signal is relatively high, and a low similarity set that is a set in which a degree of the similarity in the audio feature amount space is relatively low.

### TECHNICAL FIELD

The present invention relates to a learning apparatus, an estimation apparatus, a learning method, an estimation method, and a program.

### BACKGROUND ART

The number of pieces of audio signal data available on the Internet and the like is increasing every day, and a technology for automatically recognizing and annotating the audio signal data is an essential technology for utilizing data. Recently, a technology for audio explanatory sentence generation for generating an explanatory sentence from an audio signal has been widely studied. In the audio explanatory sentence generation, not a label but a sentence is given to an audio signal, so that the audio signal can be depicted in more detail.

### CITATION LIST

### Non Patent Literature

Non Patent Literature 1: K. Drossos, S. Adavanne, and T. Virtanen, “Clotho: An audio captioning dataset”, in Proc. IEEE Int. Conf. Acoust. Speech Signal Process. (ICASSP), 2019, pp. 736-740.

### SUMMARY OF INVENTION

### Technical Problem

By the way, for example, a scene will be considered in which explanatory sentences of It is raining very hard without any break and Rain falls at a constant and heavy rate are estimated for two pieces of audio of rain having different rainfall amounts. In such a case, it is difficult for the user to compare the two sentences and identify which is the more severe rain audio, and as a result, the user will want an explanatory sentence that describes the difference between the two pieces of audio that are similar but different.

In view of the above circumstances, an object of the present invention is to provide a technology for obtaining an explanatory sentence that describes a difference between audio signals.

### Solution to Problem

An aspect of the present invention is a learning device including a control unit that performs learning of a mathematical model of a learning target using a first audio signal and a second audio signal, in which the learning target is a disentangling model that estimates, on a basis of an embedding vector of one of two input audio signals and an embedding vector of an other, a high similarity set that is a set in which a degree of similarity between an embedding vector of the one and an embedding vector of the other in an audio feature amount space that is a space indicating a distribution of a feature amount of an embedding vector of an audio signal is relatively high, and a low similarity set that is a set in which a degree of the similarity in the audio feature amount space is relatively low, the disentangling model includes separation processing of, on a basis of an embedding vector of one of two input audio signals and an embedding vector of an other, separating both an embedding vector of the one in the audio feature amount space and an embedding vector of the other in the audio feature amount space into the high similarity set and the low similarity set, and the control unit updates the disentangling model such that a difference between the high similarity sets obtained by the separation processing is made small and a difference between the low similarity sets obtained by the separation processing is made large in the learning.

An aspect of the present invention is an estimation device including an estimation unit that executes a learned disentangling model obtained by the learning device described above.

An aspect of the present invention is a learning method including a control step of performing learning of a mathematical model of a learning target using a first audio signal and a second audio signal, in which the learning target is a disentangling model that estimates, on a basis of an embedding vector of one of two input audio signals and an embedding vector of an other, a high similarity set that is a set in which a degree of similarity between an embedding vector of the one and an embedding vector of the other in an audio feature amount space that is a space indicating a distribution of a feature amount of an embedding vector of an audio signal is relatively high, and a low similarity set that is a set in which a degree of the similarity in the audio feature amount space is relatively low, the disentangling model includes separation processing of, on a basis of an embedding vector of one of two input audio signals and an embedding vector of an other, separating both an embedding vector of the one in the audio feature amount space and an embedding vector of the other in the audio feature amount space into the high similarity set and the low similarity set, and in the control step, the disentangling model is updated such that a difference between the high similarity sets obtained by the separation processing is made small and a difference between the low similarity sets obtained by the separation processing is made large in the learning.

An aspect of the present invention is an estimation method including an estimation step of executing a learned disentangling model obtained by the learning method described above.

An aspect of the present invention is a program for causing a computer to function as any one of the learning device and the estimation device described above.

### Advantageous Effects of Invention

According to the present invention, an explanatory sentence that describes a difference between audio signals can be estimated.

### BRIEF DESCRIPTION OF DRAWINGS

FIG. 1 is an explanatory diagram illustrating an overview of an explanatory sentence generation system according to an embodiment.

FIG. 2 is a flowchart illustrating a first example of a flow of processing executed by a learning device according to the embodiment.

FIG. 3 is a flowchart illustrating a second example of a flow of processing executed by the learning device according to the embodiment.

FIG. 4 is a flowchart illustrating a third example of a flow of processing executed by the learning device according to the embodiment.

FIG. 5 is a diagram illustrating an example of a hardware configuration of the learning device according to the embodiment.

FIG. 6 is a diagram illustrating an example of a configuration of a control unit included in the learning device according to the embodiment.

FIG. 7 is a diagram illustrating an example of a hardware configuration of an estimation device according to the embodiment.

FIG. 8 is a diagram illustrating an example of a configuration of a control unit included in the estimation device according to the embodiment.

FIG. 9 is a flowchart illustrating an example of a flow of processing executed by the estimation device according to the embodiment.

FIG. 10 is an explanatory diagram for describing two types, one based on BLSTM and one based on a self-attention structure in the embodiment.

FIG. 11 is a first diagram illustrating an example of an experimental result according to the embodiment.

FIG. 12 is a second diagram illustrating an example of an experimental result according to the embodiment.

FIG. 13 is a third diagram illustrating an example of an experimental result according to the embodiment.

### DESCRIPTION OF EMBODIMENTS

### Embodiment

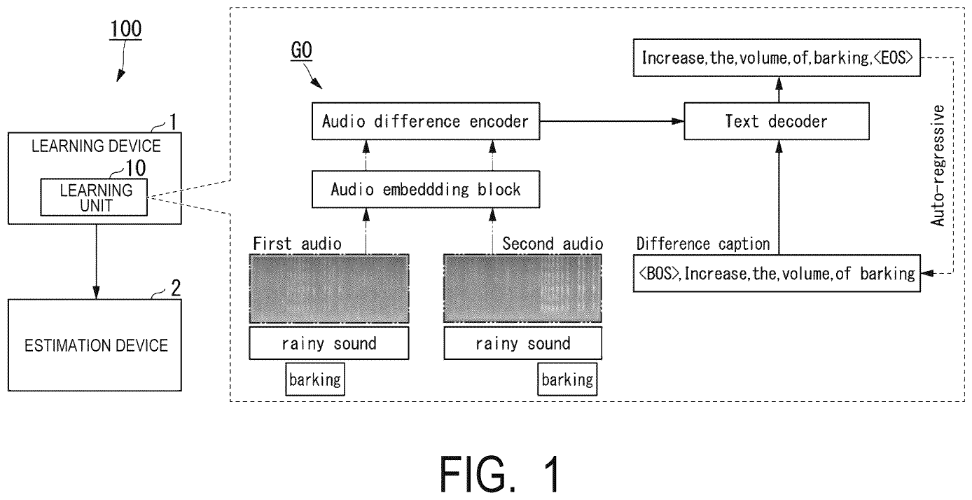

FIG. 1 is an explanatory diagram illustrating an overview of an explanatory sentence generation system 100 according to an embodiment. The explanatory sentence generation system 100 includes a learning device 1 and an estimation device 2. The learning device 1 includes a learning unit 10. The learning unit 10 learns an explanatory sentence estimation model that is a mathematical model that estimates an explanatory sentence that describes a difference between two input audio signals on the basis of the two audio signals.

Learning is executed until a predetermined condition related to an end of learning (hereinafter, referred to as a “learning end condition”) is satisfied. The learning end condition may be, for example, a condition that learning has been performed a predetermined number of times, or may be, for example, a condition that a change caused by learning of the mathematical model of the learning target is smaller than a predetermined change. There is a term “learned” in the field of machine learning, and using this term, the explanatory sentence estimation model at the time when the learning end condition is satisfied is a learned explanatory sentence estimation model.

Using the learned explanatory sentence estimation model obtained by the learning device 1, the estimation device 2 estimates an explanatory sentence that describes a difference between two audio signals input to the own device for the two audio signals.

### <First Example of Explanatory Sentence Estimation Model and Learning Method Thereof>

A first example (hereinafter referred to as “First Example”) of the explanatory sentence estimation model and the learning method thereof will be described. In First Example, the learning unit 10 performs learning of the explanatory sentence estimation model using a first audio signal that is an audio signal of the first, a second audio signal that is an audio signal different from the first audio signal, and correct explanatory sentence data. The correct explanatory sentence data is text data indicating a correct answer of an explanatory sentence that describes a difference between a sound indicated by the first audio signal and a sound indicated by the second audio signal.

In First Example, the explanatory sentence estimation model includes first embedding vector estimation processing, second embedding vector estimation processing, first linear transformation, second linear transformation, first attention processing, second attention processing, audio difference acquisition processing, and explanatory sentence estimation processing. These types of processing are executed by executing the explanatory sentence estimation model of First Example.

The first embedding vector estimation processing is processing of estimating a first embedding vector that is an embedding vector of a first input on the basis of the first input that is one of two input audio signals. Specifically, the two input audio signals are a first audio signal and a second audio signal. The content of the processing of estimating the first embedding vector on the basis of the first input may be content having a possibility of being updated by learning or content having no possibility of being updated by learning. Note that updating the content of the processing specifically means updating a value of a parameter of a mathematical model representing the processing.

The second embedding vector estimation processing is processing of estimating a second embedding vector that is an embedding vector of a second input on the basis of the second input that is the other of the two input audio signals. The content of the processing of estimating the second embedding vector on the basis of the second input may be a parameter having a possibility of being updated by learning or a parameter having a possibility of being updated by learning.

Note that, in a case where the one of the two input audio signals is the first audio signal, the other of the two input audio signals is the second audio signal. In a case where the one of the two input audio signals is the second audio signal, the other of the two input audio signals is the first audio signal.

The first embedding vector estimation processing is, for example, processing expressed by the following Formula (1), and in such a case, the second embedding vector estimation processing is, for example, processing expressed by the following Formula (2).

$$\begin{matrix}[ Math . 1 ] & \\ {e}_{1} = E ( {s}_{1} ) & ( 1 )\end{matrix}$$

$$\begin{matrix}[ Math . 2 ] & \\ {e}_{2} = E ( {s}_{2} ) & ( 2 )\end{matrix}$$

s₁ represents the first input, and s₂ represents the second input. E represents an audio embedding network. That is, E represents the content of the first embedding vector estimation processing and the second embedding vector estimation processing. e₁ represents the first embedding vector. e₂ represents the second embedding vector.

The first linear transformation is processing of performing linear transformation on the first embedding vector. The content of linear transformation of the first linear transformation may be content having a possibility of being updated by learning or content having no possibility of being updated by learning.

The second linear transformation is processing of performing linear transformation on the second embedding vector. The content of linear transformation of the second linear transformation may be content having a possibility of being updated by learning or content having no possibility of being updated by learning.

The first linear transformation is, for example, processing expressed by the following Formula (3), and in such a case, the second linear transformation is, for example, processing expressed by the following Formula (4).

$$\begin{matrix}[ Math . 3 ] & \\ {z}_{1} = Linear ( {e}_{1} ) & ( 3 )\end{matrix}$$

$$\begin{matrix}[ Math . 4 ] & \\ {z}_{2} = Linear ( {e}_{2} ) & ( 4 )\end{matrix}$$

Linear represents linear transformation. z₁ represents a result of the first linear transformation. z₂ represents a result of the second linear transformation.

The first attention processing is processing of executing an attention mechanism in which a result of the second linear transformation is used as a query and a result of the first linear transformation is used as a memory. The content of the attention mechanism in the first attention processing is content having a possibility of being updated by learning.

The second attention processing is processing of executing an attention mechanism in which a result of the first linear transformation is used as a query and a result of the second linear transformation is used as a memory. The content of the attention mechanism in the second attention processing is content having a possibility of being updated by learning.

Both the first attention processing and the second attention processing are processing for executing cross-attention of Multi-head, for example.

The audio difference acquisition processing is processing of acquiring a difference between a result of execution of the first attention processing and a result of execution of the second attention processing.

The audio difference acquisition processing is, for example, processing expressed by the following Formula (5).

$$\begin{matrix}[ Math . 5 ] & \\ M H {A}_{1} ( {z}_{2} , {z}_{1} , {z}_{1} ) - M H {A}_{2} ( {z}_{1} , {z}_{2} , {z}_{2} ) & ( 5 )\end{matrix}$$

MHA₁ represents the first attention processing, and MHA₂ represents the second attention processing. For both MHA₁ and MHA₂, the arguments represent a query, a key, and a value in the attention mechanism in order from the left. Therefore, in the first attention processing illustrated in Formula (5), the attention mechanism in which the query is z₂ and the key and the value are z₁ is executed, and in the second attention processing, the attention mechanism in which the query is z₁ and the key and the value are z₂ is executed.

The explanatory sentence estimation processing estimates an explanatory sentence that describes a difference between a sound indicated by the first input and a sound indicated by the second input on the basis of a result of the audio difference acquisition processing. The content of the explanatory sentence estimation processing is content having a possibility of being updated by learning.

The explanatory sentence estimation processing is expressed by, for example, the following Formulas (6) to (9).

$$\begin{matrix}[ Math . 6 ] & \\ {h}_{n} = LSTM ( {h}_{n - 1} , {w}_{n - 1} ) & ( 6 )\end{matrix}$$

$$\begin{matrix}[ Math . 7 ] & \\ a = softmax ( matmul ( {h}_{n} , {z}_{seq} ) ) & ( 7 )\end{matrix}$$

$$\begin{matrix}[ Math . 8 ] & \\ h = matmul ( a , {z}_{seq} ) & ( 8 )\end{matrix}$$

$$\begin{matrix}[ Math . 9 ] & \\ {o}_{n} = Linear ( tanh ( Linear ( concat ( {h}_{n} , h ) ) ) ) & ( 9 )\end{matrix}$$

LSTM means a long short term memory (LSTM). hₙ represents an output of the n-th (n is an integer of 0 or more) hidden layer in the LSTM. Therefore, n is an index that identifies a hidden layer in the LSTM. Note that a hidden layer exists if n=1 or more is satisfied, and a hidden layer of n=0 does not exist. Therefore, the value of n=0 in a symbol including n in the index means an initial value.

wₙ is text data that is a part of correct explanatory sentence data and is input to the (n+1)-th hidden layer. A part of the correct explanatory sentence data input to the (n+1)-th hidden layer is determined by the learning unit 10 in accordance with a predetermined rule, and the determined text data is input to the (n+1)-th hidden layer. The predetermined rule is, for example, a rule that the element number of a vector sequence representing text data is n-th from the smallest element number. Note that w₀ represents an initial value of text data input to the first hidden layer of the LSTM.

Formula (6) indicates that the output hₙ of the n-th hidden layer in the LSTM is obtained by the LSTM on the basis of an output hₙ₋₁ of the (n−1)-th hidden layer in the LSTM and text data wₙ₋₁.

softmax means a softmax function. matmul means a matrix product. The symbol on the left side of Formula (7) is an attention score. The symbol on the left side of Formula (8) is a context vector. Tanh means hyperbolic tangent. Concat means combining in a hidden layer direction. The symbol on the left side of Formula (9) means a decoder output.

By the processing of Formulas (6) to (9), a generation probability is estimated for each of a plurality of word strings stored in advance in a predetermined storage device. That is, by the processing of Formulas (6) to (9), information indicating a distribution of the generation probability of each of the word strings in a set of word strings stored in advance in a predetermined storage device such as a storage unit 14 to be described below is obtained.

As the initial value of the LSTM, for example, values represented by the following Formulas (10) and (11) are used.

$$\begin{matrix}[ Math . 10 ] & \\ {h}_{0} - Linear ( {z}_{pool} ) & ( 10 )\end{matrix}$$

$$\begin{matrix}[ Math . 11 ] & \\ {c}_{0} - Linear ( {z}_{pool} ) & ( 11 )\end{matrix}$$

$$\begin{matrix}[ Math . 12 ] & \\ {z}_{pool} = max ( {z}_{seq} ) + mean ( {z}_{seq} ) & ( 12 )\end{matrix}$$

h₀ represents a value of the output hₙ of the n-th hidden layer of the LSTM in a case where n=0 is satisfied. That is, h₀ represents an initial value of an output of the hidden layer of the LSTM. c₀ represents an initial value of a cell of the LSTM. max represents maximum pooling. mean represents average pooling.

In learning of the explanatory sentence estimation model of First Example, the learning unit 10 executes the explanatory sentence estimation model of First Example on the first audio signal and the second audio signal. The execution of the explanatory sentence estimation model of First Example on the first audio signal and the second audio signal specifically means that the first audio signal and the second audio signal are input to the explanatory sentence estimation model of First Example, and the explanatory sentence estimation model of First Example is executed on the input first audio signal and second audio signal.

The learning unit 10 further executes first type update processing. The first type update processing is processing of updating the explanatory sentence estimation model of First Example such that a difference between a result of estimation of the explanatory sentence estimation model of First Example and an explanatory sentence indicated by correct explanatory sentence data is made small on the basis of the result of execution of the explanatory sentence estimation model of First Example. Specifically, the result of the estimation of the explanatory sentence estimation model of First Example is the result of the estimation of the explanatory sentence estimation processing.

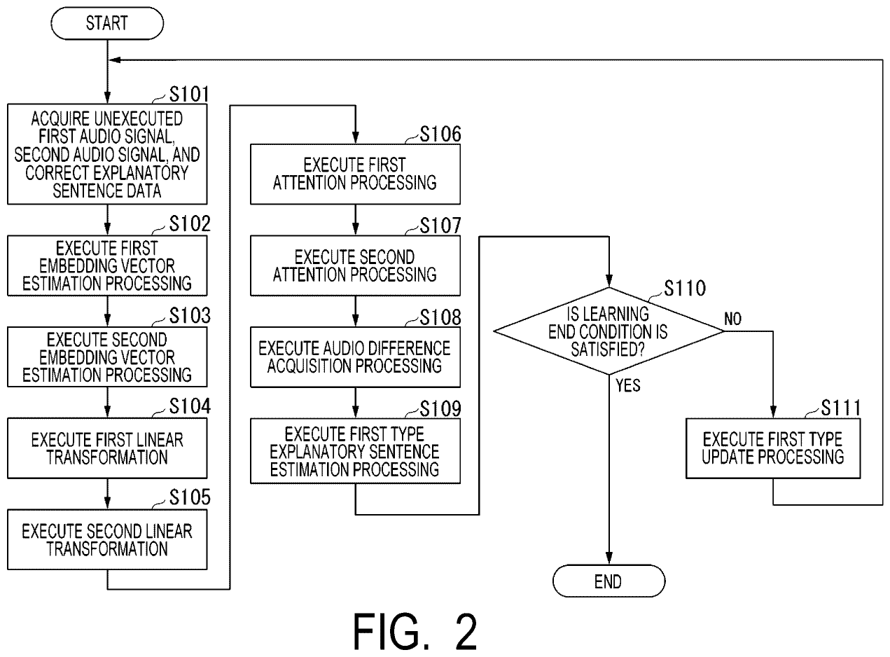

FIG. 2 is a flowchart illustrating a first example of a flow of processing executed by the learning device 1 according to the embodiment. More specifically, FIG. 2 is a flowchart illustrating an example of a flow of processing executed by the learning device 1 in a case where the explanatory sentence estimation model and the learning method thereof are according to the first example.

The learning unit 10 acquires an unexecuted set of the first audio signal, the second audio signal, and the correct explanatory sentence data. (step S101). “Unexecuted” means not yet used for learning of the explanatory sentence estimation model.

Next, the learning unit 10 executes the first embedding vector estimation processing (step S102). Next, the learning unit 10 executes the second embedding vector estimation processing (step S103). Next, the learning unit 10 executes the first linear transformation (step S104). Next, the learning unit 10 executes the second linear transformation (step S105). Next, the learning unit 10 executes the first attention processing (step S106).

Next, the learning unit 10 executes the second attention processing (step S107). Next, the learning unit 10 executes the audio difference acquisition processing (step S108). Next, the learning unit 10 executes the explanatory sentence estimation processing (step S109).

Next, the learning unit 10 determines whether the learning end condition is satisfied (step S110). The learning end condition may be, for example, a condition that a difference between a result of estimation of the explanatory sentence estimation processing and an explanatory sentence indicated by correct explanatory sentence data is smaller than a predetermined difference. If the learning end condition is satisfied (step S110: YES), the processing ends. On the other hand, if the learning end condition is not satisfied (step S110: NO), the learning unit 10 executes the first type update processing (step S111). After step S111, the processing returns to step S101.

The explanatory sentence estimation model of First Example at the time point when the learning end condition is satisfied is an example of the learned explanatory sentence estimation model.

### <Effect of First Example>

The learning device 1 formed as described above in which the explanatory sentence estimation model and the learning method thereof are according to the first example obtains a mathematical model that estimates an explanatory sentence indicating a difference between audio signals. Therefore, the learning device 1 in which the explanatory sentence estimation model and the learning method thereof are according to the first example can provide a technology of estimating an explanatory sentence that describes a difference between audio signals.

The learning device 1 formed as described above in which the explanatory sentence estimation model and the learning method thereof are according to the first example obtains a learned explanatory sentence estimation model for which learning has been performed so that a result of estimation is closer to correct answer data. Therefore, the learned explanatory sentence estimation model obtained by such a learning device 1 can estimate an explanatory sentence that describes a difference between audio signals with higher accuracy as compared with the explanatory sentence estimation model before learning. Therefore, such a learning device 1 can provide a technology of estimating an explanatory sentence that describes a difference between audio signals with higher accuracy.

The learned explanatory sentence estimation model obtained by the learning device 1 according to First Example formed as described above can estimate an explanatory sentence that describes a difference between audio signals. Therefore, if an explanatory sentence estimated by the learned explanatory sentence estimation model is added to explanatory sentences that describe two audio signals, explanatory sentences that are explanatory sentences of the two audio signals and also express the difference are generated. As described above, the learning device 1 according to First Example can generate explanatory sentences that are explanatory sentences of two audio signals and also express the difference.

### <Second Example of Explanatory Sentence Estimation Model and Learning Method Thereof>

A second example (hereinafter referred to as “Second Example”) of the explanatory sentence estimation model and the learning method thereof will be described. In Second Example, the learning unit 10 performs learning of the explanatory sentence estimation model using a first audio signal, a second audio signal, and correct explanatory sentence data.

In Second Example, the explanatory sentence estimation model includes further includes disentangling model execution processing in addition to the first embedding vector estimation processing, the second embedding vector estimation processing, the first linear transformation, the second linear transformation, the first attention processing, the second attention processing, the audio difference acquisition processing, and the explanatory sentence estimation processing. These types of processing are executed by executing the explanatory sentence estimation model of Second Example.

The disentangling model execution processing is processing of executing a disentangling model. The disentangling model is a mathematical model that estimates a high similarity set and a low similarity set on the basis of an embedding vector of one (that is, first input) of two input audio signals and an embedding vector of the other (that is, second input).

The high similarity set is a set in which the degree of similarity between the embedding vector of the first input and the embedding vector of the second input in an audio feature amount space is relatively high. The low similarity set is a set in which the degree of similarity between the embedding vector of the first input and the embedding vector of the second input in the audio feature amount space is relatively low. That is, the degree of similarity between the embedding vector of the first input and the embedding vector of the second input in the audio feature amount space is higher in the high similarity set than in the low similarity set. The audio feature amount space is a phase space indicating a distribution of feature amounts of embedding vectors of audio signals.

The disentangling model includes separation processing. The separation processing is processing of separating both the embedding vector of the first input in the audio feature amount space and the embedding vector of the second input in the audio feature amount space into the high similarity set and the low similarity set on the basis of the embedding vector of the first input and the embedding vector of the second input.

Note that the disentangling model also includes processing of acquiring a feature amount of an embedding vector. Note that the disentangling model may estimate the high similarity set and the low similarity set for each predetermined time segment. Therefore, in the separation processing, both the embedding vector of the first input in the audio feature amount space and the embedding vector of the second input in the audio feature amount space may be separated into the high similarity set and the low similarity set for each predetermined time segment.

In learning of the explanatory sentence estimation model of Second Example, the learning unit 10 executes the explanatory sentence estimation model of Second Example on the first audio signal and the second audio signal. In the learning of the explanatory sentence estimation model of Second Example, the learning unit 10 further executes second type update processing.

The second type update processing is processing of updating the explanatory sentence estimation model of Second Example such that a first difference and a second difference are made small and a third difference is made large on the basis of a result of execution of the explanatory sentence estimation model of Second Example. The first difference is a difference between a result of estimation of the explanatory sentence estimation processing and an explanatory sentence indicated by correct explanatory sentence data. The second difference is a difference between the high similarity sets obtained by the separation processing. The third difference is a difference between the low similarity sets obtained by the separation processing.

The following Formula (13) represents an example of a loss function indicating the second difference, and the following Formula (14) represents an example of a loss function indicating the third difference.

$$\begin{matrix}[ Math . 13 ] & \\ {L}_{sim} = SymInfoNCE ( Φ ( {e}_{1 , sim} ) , Φ ( {e}_{2 , sim} ) ) & ( 13 )\end{matrix}$$

$$\begin{matrix}[ Math . 14 ] & \\ {L}_{disc} = PairwiseCossim ( Ψ ( {e}_{1 , disc} ) , Ψ ( {e}_{2 , disc} ) ) & ( 14 )\end{matrix}$$

e_{1,sim} and e_{1,disc} are one and the other obtained by dividing e₁ into two, and e_{2,sim} and e_{2,disc} are one and the other obtained by dividing e₂ into two. As the learning progresses, the mathematical model (that is, disentangling model) is updated such that division of e₁ and e₂ having a higher similarity between e_{1,sim} and e_{2,sim} is performed. SymInfoNCE represents control inforNCE loss and PairwiseCossim represents a cosine similarity. Φ and Ψ are functions and, for example, functions expressed in a bidirectional-LSTM-based embedded network.

The loss function in the second type update processing may be, for example, the following loss function.

$$\begin{matrix}[ Math . 15 ] & \\ L = {L}_{CE} + λ {L}_{disent} & ( 15 )\end{matrix}$$

$$\begin{matrix}[ Math . 16 ] & \\ {L}_{disent} = {L}_{sim} + {L}_{disc} & ( 16 )\end{matrix}$$

λ represents a weight parameter.

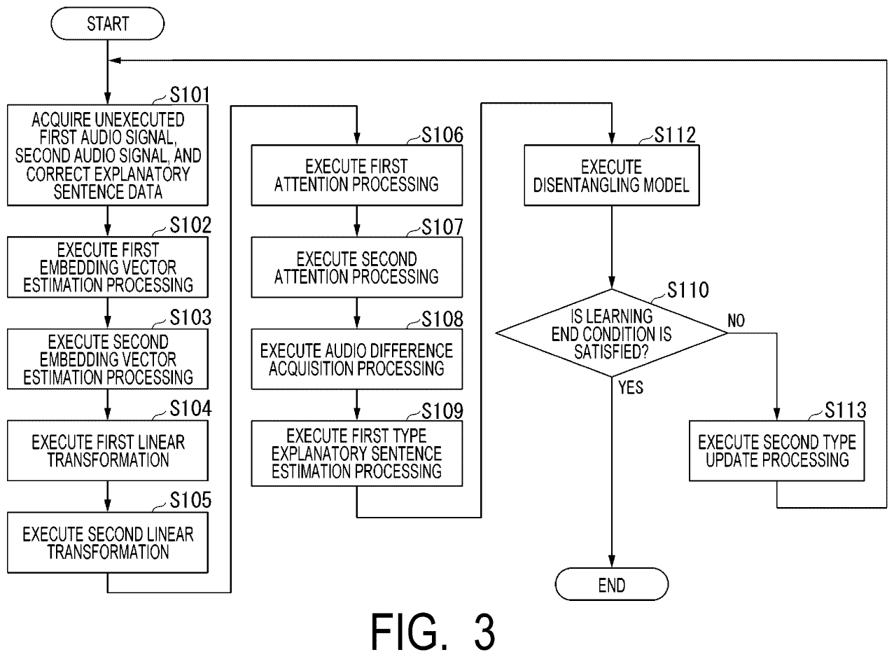

FIG. 3 is a flowchart illustrating a second example of a flow of processing executed by the learning device 1 according to the embodiment. More specifically, FIG. 3 is a flowchart illustrating an example of a flow of processing executed by the learning device 1 in a case where the explanatory sentence estimation model and the learning method thereof are according to the second example. Hereinafter, processing similar to that in FIG. 2 is denoted by the same reference numerals, and description thereof is omitted.

The processing of steps S101 to S109 is executed. Next, the learning unit 10 executes the disentangling model (step S112). The separation processing is executed by executing the disentangling model.

Next, processing of step S110 is executed. The learning end condition may be, for example, a condition that each of the first difference and the second difference is smaller than a predetermined difference and the third difference is larger than a predetermined value. If the learning end condition is satisfied (step S110: YES), the processing ends. On the other hand, if the learning end condition is not satisfied (step S110: NO), the learning unit 10 executes the second type update processing (step S113). After step S113, the processing returns to step S101.

The explanatory sentence estimation model of Second Example at the time point when the learning end condition is satisfied is an example of the learned explanatory sentence estimation model.

Note that learning of the disentangling model may be, for example, target learning.

### <Effect of Second Example>

The learning device 1 formed as described above in which the explanatory sentence estimation model and the learning method thereof are according to the second example obtains a mathematical model that estimates an explanatory sentence indicating a difference between audio signals. Therefore, the learning device 1 in which the explanatory sentence estimation model and the learning method thereof are according to the second example can provide a technology of estimating an explanatory sentence that describes a difference between audio signals.

Furthermore, in the learning device 1 formed as described above in which the explanatory sentence estimation model and the learning method thereof are according to the second example, learning is performed such that a result of estimation is closer to correct data, the degree of similarity between the high similarity sets increases, and the degree of similarity between the low similarity sets decreases. Increasing the degree of similarity between the high similarity sets and decreasing the degree of similarity between the low similarity sets means extracting a difference between two audio signals with higher accuracy.

Therefore, the learned explanatory sentence estimation model obtained by the learning device 1 of the second example formed as described above can estimate an explanatory sentence that describes a difference between audio signals with even higher accuracy as compared with the learned explanatory sentence estimation model of the first example. Therefore, such a learning device 1 can provide a technology of estimating an explanatory sentence that describes a difference between audio signals more appropriately.

The learned explanatory sentence estimation model obtained by the learning device 1 according to Second Example formed as described above can estimate an explanatory sentence that describes a difference between audio signals. Therefore, if an explanatory sentence estimated by the learned explanatory sentence estimation model is added to explanatory sentences that describe two audio signals, explanatory sentences that are explanatory sentences of the two audio signals and also express the difference are generated. As described above, the learning device 1 according to Second Example can generate explanatory sentences that are explanatory sentences of two audio signals and also express the difference.

### <Third Example of Explanatory Sentence Estimation Model and Learning Method Thereof>

A third example (hereinafter referred to as “Third Example”) of the explanatory sentence estimation model and the learning method thereof will be described. In Third Example, the learning unit 10 performs learning of the explanatory sentence estimation model using a first audio signal and a second audio signal.

In Third Example, the explanatory sentence estimation model includes the disentangling model execution processing and auxiliary estimation processing. These types of processing are executed by executing the explanatory sentence estimation model of Third Example.

The auxiliary estimation processing is processing of estimating an explanatory sentence that describes a difference between the first audio signal and the second audio signal on the basis of a result of the disentangling model execution processing. The auxiliary estimation processing may be any processing as long as it is processing of estimating an explanatory sentence that describes a difference between the first audio signal and the second audio signal on the basis of a result of the disentangling model execution processing. Therefore, the auxiliary estimation processing may be, for example, processing of executing a pre-learned auxiliary model that is not updated by learning of the explanatory sentence estimation model. The auxiliary model is a mathematical model that estimates an explanatory sentence that describes a difference between the first audio signal and the second audio signal.

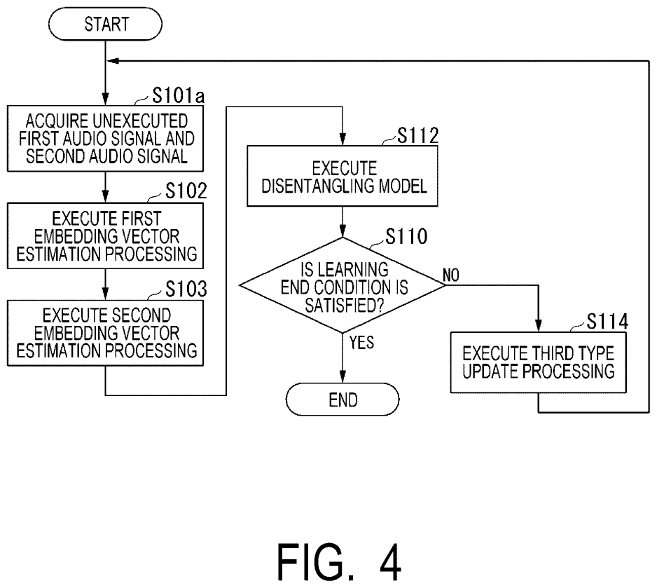

Since the auxiliary estimation processing may be processing of executing a pre-learned auxiliary model that is not updated by learning of the explanatory sentence estimation model, in such a case, learning of the explanatory sentence estimation model is learning of the disentangling model. Hereinafter, an example of a flow of processing of the learning device 1 in Third Example will be described using such a case as an example. Note that, in a case where the auxiliary model is also updated, the learning unit 10 may further perform processing of updating the auxiliary model in addition to the processing illustrated in FIG. 4.

FIG. 4 is a flowchart illustrating a third example of a flow of processing executed by the learning device 1 according to the embodiment. More specifically, FIG. 4 is a flowchart illustrating an example of a flow of processing executed by the learning device 1 in a case where the explanatory sentence estimation model and the learning method thereof are according to the third example. More specifically, FIG. 4 is a flowchart illustrating an example of a flow of processing of updating the disentangling model. Hereinafter, processing similar to that in FIG. 3 is denoted by the same reference numerals, and description thereof is omitted.

The learning unit 10 acquires an unexecuted set of the first audio signal and the second audio signal. (step S101a). Next, the processing of steps S102 and S103 is executed. Next, processing of step S112 is executed. Next, processing of step S110 is executed. The learning end condition may be, for example, a condition that the second difference is smaller than a predetermined difference and the third difference is larger than a predetermined value.

If the learning end condition is satisfied (step S110: YES), the processing ends. On the other hand, if the learning end condition is not satisfied (step S110: NO), the learning unit 10 executes third type update processing (step S114). The third type update processing is processing of updating the disentangling model such that the second difference is made small and the third difference is made large on the basis of a result of execution of the disentangling model execution processing. The loss function is, for example, the loss function of Formula (16). After step S114, the processing returns to step S101a.

The explanatory sentence estimation model of Third Example including the disentangling model at the time point when the learning end condition is satisfied is an example of the learned explanatory sentence estimation model. Note that the disentangling model at the time when the learning end condition is satisfied is a learned disentangling model.

### <Effect of Third Example>

The learning device 1 formed as described above in which the explanatory sentence estimation model and the learning method thereof are according to the third example obtains a mathematical model that estimates an explanatory sentence indicating a difference between audio signals. Therefore, the learning device 1 in which the explanatory sentence estimation model and the learning method thereof are according to the third example can provide a technology of estimating an explanatory sentence that describes a difference between audio signals.

Furthermore, in the learning device 1 formed as described above in which the explanatory sentence estimation model and the learning method thereof are according to the third example, learning is performed such that the degree of similarity between the high similarity sets increases, and the degree of similarity between the low similarity sets decreases. Increasing the degree of similarity between the high similarity sets and decreasing the degree of similarity between the low similarity sets means extracting a difference between two audio signals with higher accuracy.

Therefore, the learned explanatory sentence estimation model obtained by the learning device 1 of the third example formed as described above can estimate an explanatory sentence that describes a difference between audio signals with even higher accuracy as compared with a mathematical model on which learning of the disentangling model is not performed. Therefore, such a learning device 1 can provide a technology of estimating an explanatory sentence that describes a difference between audio signals more appropriately.

The learning device 1 of the third example formed as described above performs learning of the disentangling model. Therefore, the learned disentangling model obtained in this manner can obtain a difference between two audio signals with higher accuracy. Therefore, such a learning device 1 of the third example can provide a technology of obtaining a difference between two audio signals with higher accuracy.

The learned explanatory sentence estimation model obtained by the learning device 1 according to Third Example formed as described above can estimate an explanatory sentence that describes a difference between audio signals. Therefore, if an explanatory sentence estimated by the learned explanatory sentence estimation model is added to explanatory sentences that describe two audio signals, explanatory sentences that are explanatory sentences of the two audio signals and also express the difference are generated. As described above, the learning device 1 according to Third Example can generate explanatory sentences that are explanatory sentences of two audio signals and also express the difference.

### <Description of Hardware>

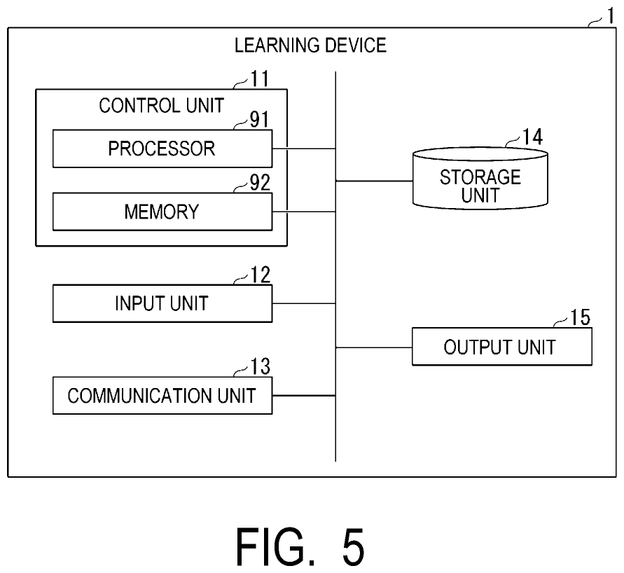

FIG. 5 is a diagram illustrating an example of a hardware configuration of the learning device 1 according to the embodiment. The learning device 1 includes a control unit 11 including a processor 91 such as a central processing unit (CPU) and a memory 92 that are connected to each other via a bus, and executes a program. The learning device 1 functions as a device including the control unit 11, an input unit 12, a communication unit 13, the storage unit 14, and an output unit 15 by executing a program.

More specifically, the processor 91 reads out the program stored in the storage unit 14 and stores the readout program in the memory 92. The learning device 1 functions as a device including the control unit 11, the input unit 12, the communication unit 13, the storage unit 14, and the output unit 15 by the processor 91 executing the program stored in the memory 92.

The control unit 11 controls operation of various functional units included in the learning device 1. The control unit 11 controls, for example, operation of the output unit 15. The control unit 11 performs, for example, learning of the explanatory sentence estimation model. The control unit 11 records various types of information generated by operation of the control unit 11 in the storage unit 14.

The input unit 12 includes an input device such as a mouse, a keyboard, or a touch panel. The input unit 12 may be configured as an interface that connects these input devices to the learning device 1. The input unit 12 receives inputs of various types of information to the learning device 1.

The communication unit 13 includes a communication interface for connecting the learning device 1 to an external device. The communication unit 13 communicates with an external device in a wired or wireless manner. The external device is, for example, a device that is a transmission source of data used for learning. The data used for learning is, for example, a set of a first audio signal, a second audio signal, and correct explanatory sentence data. The data used for learning may be, for example, a set of a first audio signal and a second audio signal. The communication unit 13 acquires data used for learning through communication with the device that is the transmission source of the data used for learning.

The external device is, for example, the estimation device 2. The communication unit 13 transmits the learned mathematical model obtained by the learning device 1 to the estimation device 2 through communication with the estimation device 2. The learned mathematical model obtained by the learning device 1 is, for example, a learned explanatory sentence estimation model. The learned mathematical model obtained by the learning device 1 may be, for example, the learned disentangling model according to Third Example. Transmitting a mathematical model means transmitting a computer program that causes a computer to execute the mathematical model.

Note that the data used for learning does not have to be necessarily input via the communication unit 13, and may be input to the input unit 12.

The storage unit 14 is configured using a computer-readable storage medium device (non-transitory computer-readable recording medium) such as a magnetic hard disk device or a semiconductor storage device. The storage unit 14 stores various types of information regarding the learning device 1. The storage unit 14 stores, for example, information input via the input unit 12 or the communication unit 13. The storage unit 14 stores, for example, various types of information generated by execution of learning. The storage unit 14 stores, for example, a learned mathematical model. For example, the storage unit 14 may store a set of word strings in advance.

The output unit 15 outputs various types of information. The output unit 15 includes, for example, a display device such as a cathode ray tube (CRT) display, a liquid crystal display, or an organic electro-luminescence (EL) display. The output unit 15 may be configured as an interface that connects these display devices to the learning device 1. The output unit 15 outputs, for example, information input to the input unit 12. The output unit 15 may display, for example, a result of updating the mathematical model by learning.

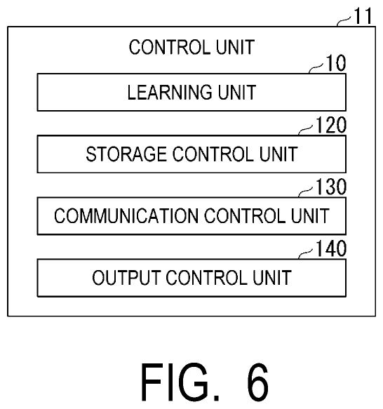

FIG. 6 is a diagram illustrating an example of a configuration of the control unit 11 included in the learning device 1 according to the embodiment. The control unit 11 includes the learning unit 10, a storage control unit 120, a communication control unit 130, and an output control unit 140. The storage control unit 120 records various types of information in the storage unit 14. The communication control unit 130 controls operation of the communication unit 13. The output control unit 140 controls operation of the output unit 15.

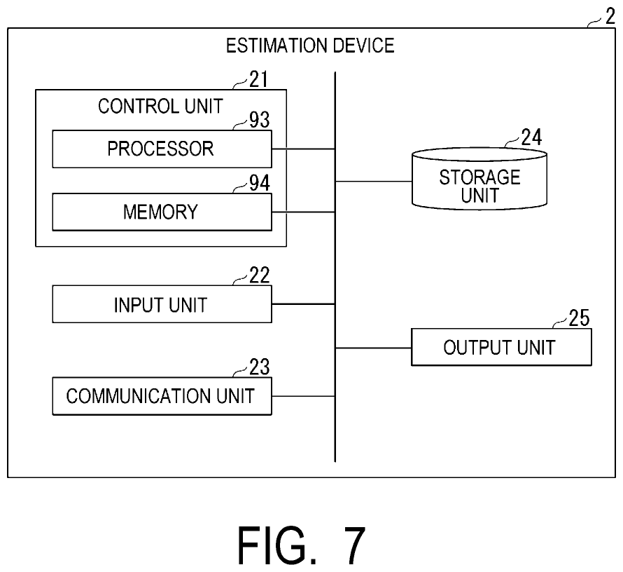

FIG. 7 is a diagram illustrating an example of a hardware configuration of the estimation device 2 according to the embodiment. The estimation device 2 includes a control unit 21 including a processor 93 such as a CPU and a memory 94 that are connected to each other via a bus, and executes a program. The estimation device 2 functions as a device including the control unit 21, an input unit 22, a communication unit 23, a storage unit 24, and an output unit 25 by executing a program.

More specifically, the processor 93 reads out the program stored in the storage unit 24, and stores the readout program in the memory 94. The estimation device 2 functions as a device including the control unit 21, the input unit 22, the communication unit 23, the storage unit 24, and the output unit 25 by the processor 93 executing the program that the memory 94 is caused to store.

The control unit 21 controls operation of various functional units included in the estimation device 2. The control unit 21 controls, for example, operation of the output unit 25. The control unit 21 executes the learned mathematical model obtained by the learning device 1, such as the learned explanatory sentence estimation model or the learned disentangling model according to Third Example. The control unit 21 records various types of information generated by operation of the control unit 21 in the storage unit 24.

The input unit 22 includes an input device such as a mouse, a keyboard, or a touch panel. The input unit 22 may be configured as an interface that connects these input devices to the estimation device 2. The input unit 22 receives inputs of various types of information to the estimation device 2.

The communication unit 23 is configured to include a communication interface for connecting the estimation device 2 to an external device. The communication unit 23 communicates with an external device in a wired or wireless manner. The external device is, for example, a device that is a transmission source of an audio signal. The communication unit 23 acquires an audio signal through communication with a transmission source device of the audio signal.

The external device is, for example, the learning device 1. The communication unit 23 acquires the learned mathematical model obtained by the learning device 1, such as the learned explanatory sentence estimation model or the learned disentangling model according to Third Example, through communication with the learning device 1. The audio signal does not have to be necessarily input via the communication unit 23, and may be input to the input unit 22.

The storage unit 24 is configured using a computer-readable storage medium device (non-transitory computer-readable recording medium) such as a magnetic hard disk device or a semiconductor storage device. The storage unit 24 stores various types of information related to the estimation device 2. The storage unit 24 stores, for example, information input via the input unit 22 or the communication unit 23. The storage unit 24 stores various types of information generated by execution of the learned mathematical model, such as the learned explanatory sentence estimation model or the learned disentangling model according to Third Example. The storage unit 24 stores the learned mathematical model obtained by the learning device 1, such as the learned explanatory sentence estimation model or the learned disentangling model according to Third Example.

The output unit 25 outputs various types of information. The output unit 25 includes, for example, a display device such as a CRT display, a liquid crystal display, or an organic EL display. The output unit 25 may be configured as an interface that connects these display devices to the estimation device 2. The output unit 25 outputs, for example, information input to the input unit 22. The output unit 25 may display a result of estimation by the learned mathematical model obtained by the learning device 1, such as the learned explanatory sentence estimation model or the learned disentangling model according to Third Example.

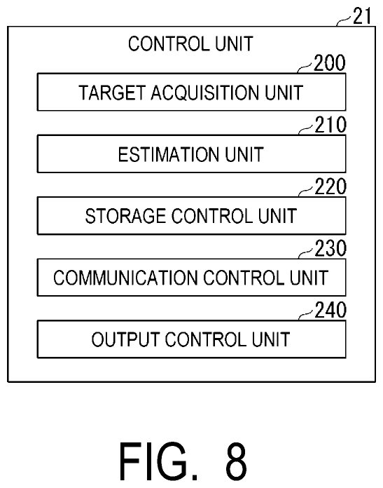

FIG. 8 is a diagram illustrating an example of a configuration of the control unit 21 included in the estimation device 2 according to the embodiment. The control unit 21 includes a target acquisition unit 200, an estimation unit 210, a storage control unit 220, a communication control unit 230, and an output control unit 240.

The target acquisition unit 200 acquires information input to the input unit 22 or the communication unit 23. Therefore, the target acquisition unit 200 acquires, for example, two audio signals input to the input unit 22 or the communication unit 23. In a case where the target acquisition unit 200 acquires two audio signals, the estimation unit 210 executes, on those signals, the learned mathematical model obtained by the learning device 1, such as the learned explanatory sentence estimation model or the learned disentangling model according to Third Example.

In a case where the learned explanatory sentence estimation model is executed, the estimation unit 210 estimates an explanatory sentence that describes a difference between two audio signals acquired by the target acquisition unit 200. In a case where the learned disentangling model according to Third Example is executed, the estimation unit 210 acquires an execution result of the learned disentangling model for two audio signals acquired by the target acquisition unit 200. That is, in a case where the learned disentangling model according to Third Example is executed, the estimation unit 210 estimates a difference between two audio signals acquired by the target acquisition unit 200.

The storage control unit 220 records various types of information in the storage unit 24. The communication control unit 230 controls operation of the communication unit 23. The output control unit 240 controls operation of the output unit 25.

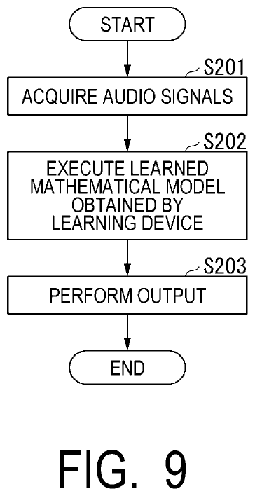

FIG. 9 is a flowchart illustrating an example of a flow of processing executed by the estimation device 2 according to the embodiment. The target acquisition unit 200 acquires two audio signals (step S201). Next, the estimation unit 210 executes the learned mathematical model obtained by the learning device 1 on the two audio signals acquired in step S201 (step S202). The learned mathematical model obtained by the learning device 1 is, for example, a learned explanatory sentence estimation model. The learned mathematical model obtained by the learning device 1 is, for example, a learned disentangling model.

Next, the output control unit 240 controls the operation of the output unit 25 to cause the output unit 25 to output the result obtained in step S202 (step S203).

### <Experiment Result>

An example of an experimental result will be described. As an experiment, an AudoDiffCaps data set was constructed, and the effect of the learned mathematical model obtained by the learning device 1 was verified. The AudoDiffCaps data set was a data set synthesized using audio files of FSD50k and ESC-50, which are data sets for audio tagging, and was a data set obtained by combining a pair of similar but different audio signals and a text that describes the difference as a set.

Data labeled with “rain” and “car passing” in the FSD50k as a background sound and data labeled with “dog”, “chirping bird”, “thunder”, “footsteps”, “car horn”, and “church bell” in the ESC-50 as an event sound were used for synthesis. 5996 pairs of training sets and 1720 pairs of evaluation sets were prepared. Up to five sentences of texts that describe differences are given per pair in the training sets, and five sentences are always given per pair in the evaluation sets.

In the training, 10% of each of the training sets was used as a verification set. 300 epochs using Adam were performed for optimization, and a model having the smallest value of the loss function in the verification set was used for evaluation. BLEU-1, BLEU-4, METEOR, ROUGE-L, CIDEr, SPICE, and SPIDEr were used for evaluation. These are evaluation indices that are also used in existing audio explanatory sentence generation. As a pre-learned model of an audio embedding block, BYOL-A (see Reference Literature 1) and CNN14 of PANNs (see Reference Literature 2) were used.

As comparison methods, two baselines and two audio difference encoders (ADEs) were used. The two baselines are both single-input BLSTM-LSTM structures, which are widely utilized in existing audio explanatory sentence generation. For the input, each of one obtained by subtracting the two audio signals in the time domain and one obtained by combining two audio embedding representations in the time direction were used.

As two types of ADEs other than the proposed methods, one based on BLSTM and one based on a self-attention structure were prepared. By comparison with these, it has been performed in the experiment to confirm the effectiveness of a cross-attention structure in which a long sequence can be efficiently handled and a similarity of two audio signals for each time segment can be considered in audio difference explanatory sentence generation.

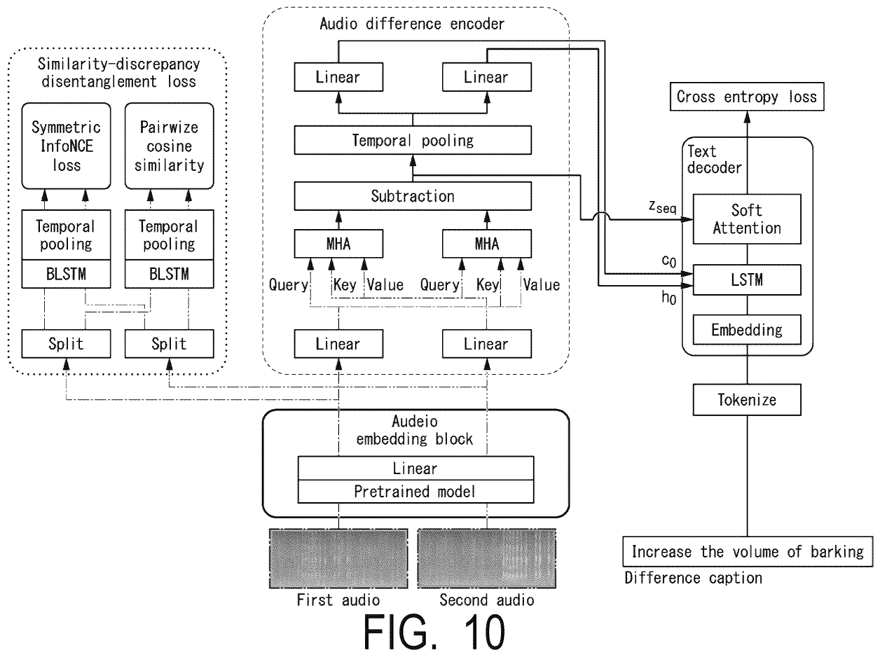

FIG. 10 is an explanatory diagram for describing two types, one based on BLSTM and one based on a self-attention structure in the embodiment. FIG. 10 itself is a diagram for describing processing executed by the learning device 1 in Second Example. The above one based on BLSTM is one that replaces “MHA” in FIG. 10 with BLSTM and performs execution. Furthermore, the above one based on the self-attention structure is one that does not perform switching of queries as executed by the learning device 1 in two attention mechanisms described as “MHA” in the processing of FIG. 10. That is, the query of MHA including the key and the value z₁ is z₁, and the query of MHA including the key and the value z₂ is z₂.

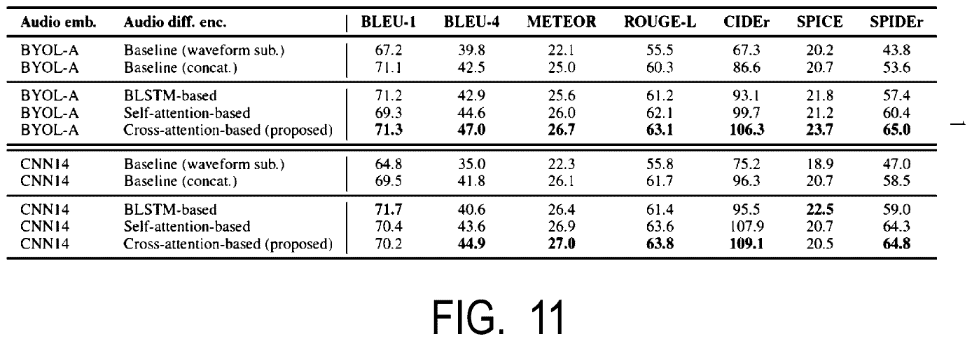

FIG. 11 is a first diagram illustrating an example of an experimental result according to the embodiment. More specifically, FIG. 11 is an example of an experimental result of learning and evaluation without using disentangling loss in order to compare the learned mathematical model obtained by the learning device 1 in Second Example with the ADEs of the comparison methods. FIG. 11 illustrates that an ADE based on cross-attention proposed by excluding BLEU-1 and SPICE in a case where CNN14 is used as a preliminary learning model of an audio embedding block obtains the best value of the evaluation index.

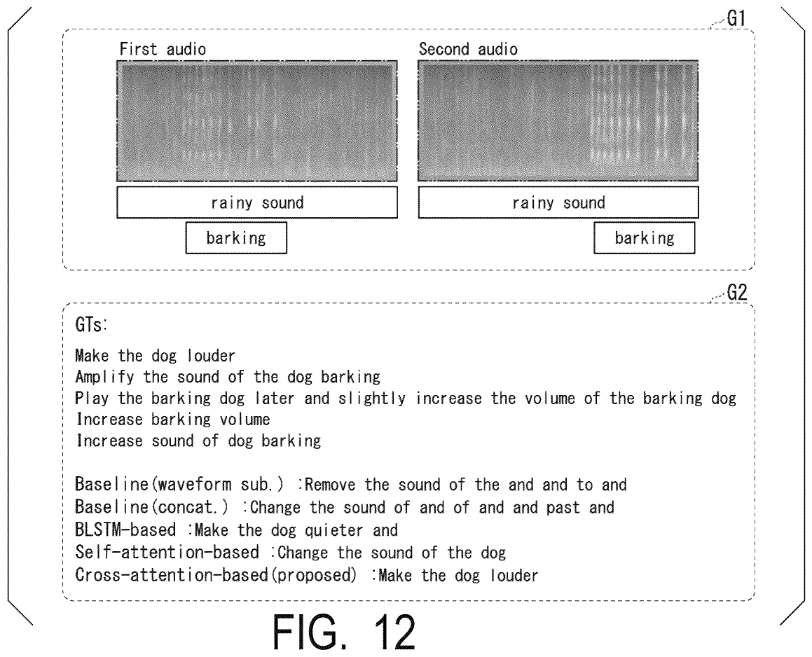

An example of an estimated explanatory sentence of each condition is illustrated in FIG. 12. Therefore, FIG. 12 is a second diagram illustrating an example of an experimental result according to the embodiment. An image G1 in FIG. 12 illustrates two input audio signals. An image G2 in FIG. 12 illustrates a ground truth captions (GTs) of an explanatory sentence and a result estimated by each model.

FIG. 12 illustrates that neither baseline was able to output “dog barking” that is an audio event that makes a difference. FIG. 12 illustrates that the audio event that makes a difference can be recognized in the ADEs based on BLSTM and self-attention, but “the sound becomes loud” that is the type of the difference cannot be properly output as an explanatory sentence. On the other hand, FIG. 12 illustrates that an explanatory sentence in which both the audio event and the type of the difference are described can be output in the learned mathematical model obtained by the learning device 1 according to Second Example.

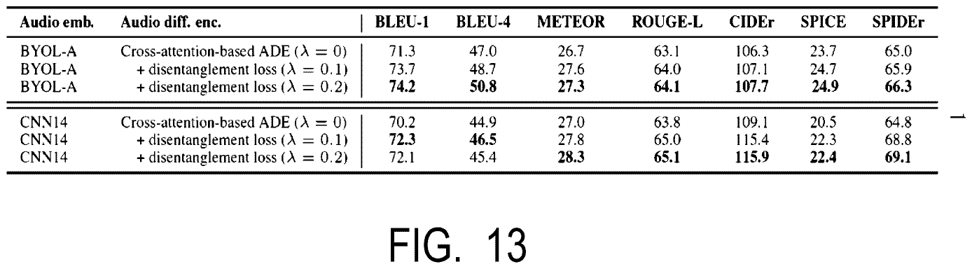

In the experiment, learning and evaluation were performed with the weight parameter A set to 0, 0.1, and 0.2 in order to confirm the effect of the disentangling loss. The ADE is fixed to one based on cross-attention. Results are illustrated in FIG. 13. Therefore, FIG. 13 is a third diagram illustrating an example of an experimental result according to the embodiment.

FIG. 13 illustrates that a method using the disentangling loss obtains the best value of an evaluation index when using either of preliminary learning models. Furthermore, FIG. 13 illustrates that the increase (+4.3) in the value of SPIDEr when CNN14 is used as the preliminary learning model is significantly larger than a case of BYOL-A (+1.3).

The estimation device 2 that is formed as described above and performs estimation using the learned explanatory sentence estimation model obtained by the learning device 1 of First Example performs estimation using the learned explanatory sentence estimation model obtained by the learning device 1 of First Example. The learning device 1 of First Example has the effect described in <Effect of First Example>. Therefore, such an estimation device 2 can also provide a technology of estimating an explanatory sentence that describes a difference between audio signals. Furthermore, a technology of estimating an explanatory sentence that describes a difference between audio signals with higher accuracy can be provided. Furthermore, explanatory sentences that are explanatory sentences of two audio signals and also express the difference can be generated.

The estimation device 2 that is formed as described above and performs estimation using the learned explanatory sentence estimation model obtained by the learning device 1 of Second Example performs estimation using the learned explanatory sentence estimation model obtained by the learning device 1 of Second Example. The learning device 1 of Second Example has the effect described in <Effect of Second Example>. Therefore, such an estimation device 2 can also provide a technology of estimating an explanatory sentence that describes a difference between audio signals. Furthermore, a technology of estimating an explanatory sentence that describes a difference between audio signals more appropriately can be provided. Furthermore, explanatory sentences that are explanatory sentences of two audio signals and also express the difference can be generated.

The estimation device 2 that is formed as described above and performs estimation using the learned explanatory sentence estimation model obtained by the learning device 1 of Third Example performs estimation using the learned explanatory sentence estimation model obtained by the learning device 1 of Third Example. The learning device 1 of Third Example has the effect described in <Effect of Third Example>. Therefore, such an estimation device 2 can also provide a technology of estimating an explanatory sentence that describes a difference between audio signals. Furthermore, a technology of estimating an explanatory sentence that describes a difference between audio signals more appropriately can be provided. Furthermore, explanatory sentences that are explanatory sentences of two audio signals and also express the difference can be generated.

The estimation device 2 that is formed as described above and performs estimation using the learned disentangling model obtained by the learning device 1 of Third Example performs estimation using the learned disentangling model obtained by the learning device 1 of Third Example. The learning device 1 of Third Example has the effect described in <Effect of Third Example>. Therefore, such an estimation device 2 can provide a technology of obtaining a difference between two audio signals with higher accuracy.

### Modifications

Note that the learning device 1 may be implemented by using a plurality of information processing devices communicably connected to each other via a network. In this case, the functional units included in the learning device 1 may be implemented in a distributed manner in the plurality of information processing devices.

The estimation device 2 may be implemented by using a plurality of information processing devices communicably connected to each other via a network. In this case, each functional unit included in the estimation device 2 may be implemented in a distributed manner in the plurality of information processing devices.

Note that all or some of the functions of the learning device 1 and the estimation device 2 may be implemented by using hardware such as an application specific integrated circuit (ASIC), a programmable logic device (PLD), or a field programmable gate array (FPGA). The program may be recorded in a computer-readable recording medium. The computer-readable recording medium is, for example, a portable medium such as a flexible disk, a magneto-optical disk, a ROM, or a CD-ROM or a storage device such as a hard disk built in a computer system. The program may be transmitted via an electrical communication line.

Although the embodiment of this invention has been described in detail with reference to the drawings, specific configurations are not limited to the embodiment and include design and the like within the gist of this invention.

### REFERENCE SIGNS LIST

100 Explanatory sentence generation system
1 Learning device
2 Estimation device
10 Learning unit
11 Control unit
12 Input unit
13 Communication unit
14 Storage unit
15 Output unit
120 Storage control unit
130 Communication control unit
140 Output control unit
21 Control unit
22 Input unit
23 Communication unit
24 Storage unit
25 Output unit
200 Target acquisition unit
210 Estimation unit
220 Storage control unit
230 Communication control unit
240 Output control unit
91 Processor
92 Memory
93 Processor
94 Memory

1. A learning device comprising:
a processor;
a storage medium having computer program instructions stored thereon, wherein the computer program instructions, when executed by the processor, perform processing of:
performing learning of a mathematical model of a learning target using a first audio signal and a second audio signal,
wherein the learning target is a disentangling model that estimates, on a basis of an embedding vector of one of two input audio signals and an embedding vector of an other, a high similarity set that is a set in which a degree of similarity between an embedding vector of the one and an embedding vector of the other in an audio feature amount space that is a space indicating a distribution of a feature amount of an embedding vector of an audio signal is relatively high, and a low similarity set that is a set in which a degree of the similarity in the audio feature amount space is relatively low,
the disentangling model includes separation processing of, on a basis of an embedding vector of one of two input audio signals and an embedding vector of an other, separating both an embedding vector of the one in the audio feature amount space and an embedding vector of the other in the audio feature amount space into the high similarity set and the low similarity set, and
the computer program instructions perform processing of updating the disentangling model such that a difference between the high similarity sets obtained by the separation processing is made small and a difference between the low similarity sets obtained by the separation processing is made large in the learning.

2. The learning device according to claim 1,
wherein the computer program instructions perform processing of:
performing learning of an explanatory sentence estimation model that is a mathematical model that estimates an explanatory sentence that describes a difference between two input audio signals further using correct explanatory sentence data indicating a correct answer of an explanatory sentence that describes a difference between a sound indicated by the first audio signal and a sound indicated by the second audio signal, the explanatory sentence estimation model also including the disentangling model,
wherein the explanatory sentence estimation model includes:
execution of the disentangling model;
first embedding vector estimation processing of estimating a first embedding vector that is an embedding vector of one of the two input audio signals on a basis of the one;
second embedding vector estimation processing of estimating a second embedding vector that is an embedding vector of an other of the two input audio signals on a basis of the other;
first linear transformation that performs linear transformation on the first embedding vector;
second linear transformation that performs linear transformation on the second embedding vector;
first attention processing of executing an attention mechanism in which a result of the second linear transformation is used as a query and a result of the first linear transformation is used as a memory;
second attention processing of executing an attention mechanism in which a result of the first linear transformation is used as a query and a result of the second linear transformation is used as a memory;
audio difference acquisition processing of acquiring a difference between a result of execution of the first attention processing and a result of execution of the second attention processing; and
explanatory sentence estimation processing of estimating explanatory sentence data of an explanatory sentence that describes a difference between a sound indicated by the one and a sound indicated by the other on a basis of a result of the audio difference acquisition processing.

3. (canceled)

4. A learning method comprising:
performing learning of a mathematical model of a learning target using a first audio signal and a second audio signal,
wherein the learning target is a disentangling model that estimates, on a basis of an embedding vector of one of two input audio signals and an embedding vector of an other, a high similarity set that is a set in which a degree of similarity between an embedding vector of the one and an embedding vector of the other in an audio feature amount space that is a space indicating a distribution of a feature amount of an embedding vector of an audio signal is relatively high, and a low similarity set that is a set in which a degree of the similarity in the audio feature amount space is relatively low,
the disentangling model includes separation processing of, on a basis of an embedding vector of one of two input audio signals and an embedding vector of an other, separating both an embedding vector of the one in the audio feature amount space and an embedding vector of the other in the audio feature amount space into the high similarity set and the low similarity set, and
in the performing, the disentangling model is updated such that a difference between the high similarity sets obtained by the separation processing is made small and a difference between the low similarity sets obtained by the separation processing is made large in the learning.

5. (canceled)

6. A non-transitory computer readable medium which stores a program for causing a computer to function as the learning device according to claim 1.
